(19) United States
(12) Patent Application Publication
(10) Pub. No.: US 2015/0278256 A1
(43) Pub. Date: Oct. 1, 2015

(54) INTERMEDIATE LAYER, A DATABASE META-DESCRIPTION LAYER, A DATABASE, A DATABASE SYSTEM, A COMPUTER AND A COMPUTER SYSTEM

(71) Applicant: DATENLOTSEN INFORMATIONSSYSTEME GMBH, HAMBURG (DE)

(72) Inventors: DOMINIK MAASS, Hamburg (DE); STEPHAN SACHSE, Hamburg (DE)

(21) Appl. No.: 14/673,879

(22) Filed: Mar. 31, 2015

(30) Foreign Application Priority Data
Apr. 1, 2014 (DE) 10 2014 104 568.8

(51) Int. Cl. G06F 17/30

(52) U.S. Cl. CPC G06F 17/30289; G06F 17/30557

(57) ABSTRACT

An intermediate layer for abstracting a database meta-description layer with a coupling unit and an access interface configured to be object-oriented. A connection with the database meta-description layer is implementable by the coupling unit. The database meta-description layer refers to a first database field and/or other database fields of a first database and/or other databases via a meta-description of the first database and/or other databases, via a first reference and/or other references, so that the first database and/or other databases are at least one of accessible and manipulable. The access interface comprises an object-oriented configuration so that the first database and/or other databases is/are at least one of accessible and manipulable via object-oriented calls of the access interface by using at least one of the meta-description, the first reference, and the other references.

### CROSS REFERENCE TO PRIOR APPLICATIONS

Priority is claimed to German Patent Application No. DE 10 2014 104 568.8, filed Apr. 1, 2014. The entire disclosure of said application is incorporated by reference herein.

### FIELD

The present invention relates to an intermediate layer for abstracting a database meta-description layer with an access interface and a coupling unit, wherein a connection with the database meta-description layer is implementable by means of the coupling unit and the database meta-description layer accesses and/or manipulates a first database and/or other databases by means of a meta-description of the first database and/or other databases and by means of a first reference and/or of other references to a first database field and/or to other database fields, so that the first database and/or the other databases is and/or are accessible and/or manipulable, and a data meta-description layer, which comprises the intermediate layer as well as a database, a database system, a computer or a computer system.

### BACKGROUND

It is necessary nowadays to combine data of a great variety of databases and, in particular, of a great variety of database models, and to provide it to a user. To this end, software packages have been provided which have meta-descriptions of the underlying databases and references to individual database fields so that, for example, a database field in the table underlying the database may be changed.

Such software environments additionally allow data manipulation at the meta level so that it is possible to work with several databases in an integrated manner. A typical example of such software packages is the XPA software from the company Magic®.

Such software applications have the advantage that graphical user interfaces are provided on a great variety of terminals, with a great variety of visualization software applications, such as, e.g., browsers, so that respective end users have an identical view of their information irrespective of the terminal used.

A disadvantage of such systems is that in order for the end user to view the information, the so-called graphical user interfaces (GUI) must be used in a proprietary manner. This means in particular that the possible graphical elements are limited to the functionalities that the respective software producer provides for the database meta-description layer. The more specific consequence thereof is that an end user is limited when configuring his own GUI.

### SUMMARY

An aspect of the present invention is to improve upon the prior art.

In an embodiment, the present invention provides an intermediate layer for abstracting a database meta-description layer with a coupling unit and an access interface configured to be object-oriented. A connection with the database meta-description layer is implementable by the coupling unit. The database meta-description layer refers to a first database field and/or other database fields of a first database and/or other databases via a meta-description of the first database and/or other databases, via a first reference and/or other references, so that the first database and/or other databases are at least one of accessible and manipulable. The access interface comprises an object-oriented configuration so that the first database and/or other databases is/are at least one of accessible and manipulable via object-oriented calls of the access interface by using at least one of the meta-description, the first reference, and the other references.

### BRIEF DESCRIPTION OF THE DRAWING

The present invention is described in greater detail below on the basis of embodiments and of the drawings in which:

FIG. 1 shows a highly schematic representation of a computer system with the individual layers used.

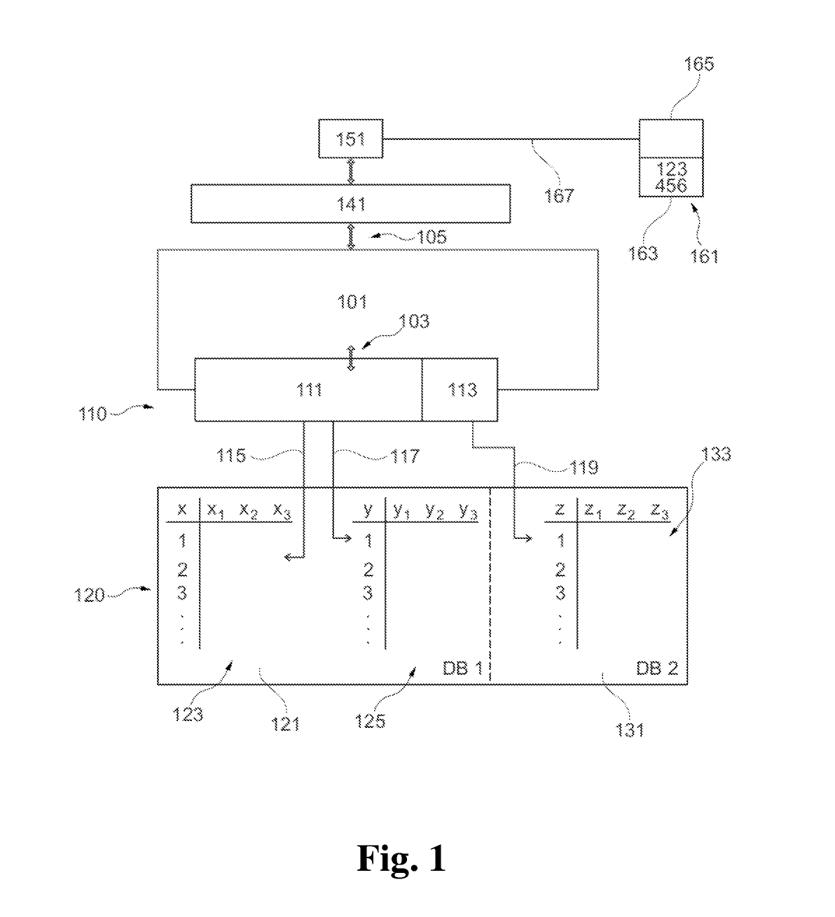

### DETAILED DESCRIPTION

In an embodiment, the present invention provides an intermediate layer for abstracting a database meta-description layer with an access interface and a coupling unit, wherein a connection with the database meta-description layer is implementable and the database meta-description layer refers to a first database field and/or to other database fields of a first database and/or other databases by means of a meta-description of the first data base and/or of an other database and by means of a first reference and/or other references, so that the first database and/or the other databases is and/or are accessible and/or manipulable, wherein the access interface is designed to be object-oriented, so that the first database and/or the other databases is and/or are accessible and/or manipulable by means of object-oriented calls of the access interface by using the meta-description and/or the first reference and/or the other references.

An integrated object-oriented access and manipulation of the underlying database or the underlying databases is thus made possible. In particular, the restrictions caused by a proprietary structure do not apply.

Users using the underlying database and/or databases can also create a graphical user interface or rather interface elements designed in accordance with their needs.

This solution furthermore provides an open standard for accessing meta-descriptions of a database or of databases by way of the intermediate layer.

While the prior art requires specialists that must have knowledge of the database at the level of the database meta-description layer, it is now possible, by implementing the intermediate layer according to the present invention, to access the database without any knowledge on the underlying database model. Complexity is thereby significantly reduced, and the end users are more rapidly able to implement possible manipulations or designs of their own graphical interface and to perform desired database manipulations. The manipulation (e.g., writing or reading) of the individual data items, or the extraction of specific information that can only be obtained by interpreting closer tables, can also be made easier for an end user since the end user does not have to familiarize himself/herself with each individual database structure.

The following terms used herein are defined as follows:

The “intermediate layer” in particular refers to a programming code which generates specific outputs according to specific inputs. Queries are in particular fed “through the layer” and manipulated so that an effective communication can take place, in particular, with another interface.

Interfaces are in particular part of a system which serves for communication. The exchange of information generally takes place in form of physical (e.g., electrical voltage of a current) or logical values (data), and can take place analogously as well as digitally. The present application in particular includes software interfaces which connect programs logically with each other. In the present case, the interfaces are in particular a formal declaration of which functions are available and how they can be accessed. This is advantageous in the present application because modules having the same interface can be exchanged. Another advantage is that available interfaces, or rather, the intermediate layer with its interfaces, can consequently be built on top of an abstract data description of a database.

The intermediate layer in particular has two interfaces in the present application. Firstly, the “access interface”, through which individual database queries or manipulations can be input. Secondly, the “coupling unit”, which is in particular a special form of the interface, since it can be described formally or directly connects a part of the meta-description layer with the intermediate layer, so that, in the present case, the intermediate layer and the meta-description layer are thereby coupleable and can form a unit.

A query, which accesses the access interface, is thus in particular translated by the intermediate layer, in particular by means of software so that the underlying functionalities of the database meta-description layer are used.

A “database meta-description layer” comprises meta-information of the underlying database or databases. An example of a commercially available software application which provides such a database meta-description layer is in particular the software package XPA by the company Magic®.

The “meta-descriptions” are in particular the individual table information located, for example, in an underlying relational database. For example, in a university management software application, a table “STUDENT” can be created in the database. This table in particular contains a unique key and information such as a name, a student number, a field of study, and a status of the student.

Since this information is comprised of numbers as well as general characters of different lengths, a specific type of data, such as an integer or a string, is stored in the database for the respective database field that is filled out.

The “meta-description” of the database accommodates general information about the table “STUDENT” and not particular contents of the particular database fields. This general information is, for example, that the table contains a column “NAME” and string-type data.

This meta-description further includes the STUDENT NUMBER with the data type integer, the FIELD OF STUDY with the data type string, and the STUDENT STATUS with the data type shortint.

The meta-description also stores information about how the particular tables can be accessed so that particular database fields of the table can be filled as required.

Various tables can also be linked, or certain data manipulations, e.g., incremental counting of a specific data field, stored or implemented in the database meta-description layer.

The “database” or the “databases” are systems for electronic data management. A database is sometimes also referred to as a database system; in the present description both must be understood as synonyms. The fundamental function of such databases is to store great amounts of data in an efficient, consistent and durable manner, and to provide required subsets in a display format adapted to the needs of the user, and to provide application software.

A database system is in particular composed of two parts. Firstly, a management software application, which is also referred to as a database management system and, secondly, the database in the strict sense, which is sometimes also referred to as a data basis.

The management software application internally organizes the structured storage of the data and controls all the reading and writing accesses to the database. A database system generally also provides a database language for queries and management of the data. The manner in which data is stored in databases/database systems is referred to as a database model. In the present application, the database systems can in particular be relational database systems. Other database systems such as hierarchical, network, or document-oriented database systems, are also included in the present application. The meta-description is therefore in particular an abstract description of the database model.

When “accessing” the database, the data stored in the database can be read out of the database and in particular transported via the database meta-description layer and passed on to the intermediate layer.

When “manipulating” the database, particular database fields are overwritten or, e.g., tables with appropriate structures are created.

The “access interface” is in particular designed in an “object-oriented” manner. It in particular provides the structures and functionalities known from the object-oriented programming. This object-oriented access interface thus constitutes a description abstracted into a meta-description, which makes it possible to use and process the information in the database irrespective of knowledge about the underlying database models or meta-descriptions.

In an embodiment of the present invention, the object-oriented access interface comprises classes, objects, methods, functions and/or attributes, through which a distinct database call or a distinct database manipulation is implementable.

An object-oriented framework can thus be provided which offers known object-oriented methods and processes. The object-oriented access interface consequently represents an object-oriented programming paradigm. The underlying concepts, such as abstraction, class, prototype, data encapsulation, feedback, persistence, polymorphism, and inheritance, are consequently implemented. Reference is made to textbooks on object-oriented programming whose contents in this regard constitute part of the present application.

“Objects” can, for example, be created by instantiating a “class”. These objects can have “properties” or corresponding attributes and can provide “methods”. “Functions” or methods can also act on objects.

In an embodiment, the present invention provides a database meta-description layer for describing and communicating with a database or with several databases, with a previously described intermediate layer.

The previously described intermediate layer can thus be advantageously combined with the database meta-description layer and thus makes it possible to allow for an optimized adaptation to a database or to several databases.

In an embodiment, the present invention provides the database meta-description layer with a programming which implements a manipulation of database contents and which has been written by means of a programming environment, with which the meta-description and the reference or references of the database or databases have been adapted.

This particular form of database meta-description layer is consequently a development environment that allows a user to implement the individual abstractions of the databases and of the corresponding references.

In order to optimally merge the database meta-description layer, the functionality of the intermediate layer can be written by means of the programming environment.

A global layer can also be provided in which data is efficiently exchanged between the intermediate layer and the database meta-description layer.

In an embodiment, the present invention provides a database to which a previously described database meta-description layer is assigned so that an access to the database or a manipulation of the database is implementable by way of the object-oriented access interface of the intermediate layer of the database meta-description layer.

Specific functionalities can in particular be diverted to the corresponding instance or layer in which it can be executed optimally and in a time-efficient manner. It is also possible to carry out actions at the database level and actions on the database meta-description layer or in the actual intermediate layer.

An integrated database system with an abstract description and an object-oriented access can thus be provided.

In order to use information from several databases, the present invention provides a database system which has two or more databases, to which exactly one previously described database meta-description layer is attributed, so that the databases are accessible and/or manipulable together, in parallel, or in a complementary manner.

For example, at a university, the staff database and the student management database can be worked on with a single integrated system. An overall object-oriented access of the databases is thus implementable.

In the present application, at least two databases can in particular have a different data model so that heterogeneous systems are manipulable or accessible in an integrated, object-oriented manner.

In an embodiment, the present invention provides a computer or a computer system which comprises a previously described database and/or a previously described database system.

A hardware infrastructure with a corresponding software application can thus be provided which implements the previously described advantages of the intermediate layer and/or of the database meta-description layer and/or the database and/or the database system.

In an embodiment, the present invention provides a service layer which accesses the object-oriented access interface and comprises services which are attributable to a display layer and/or to a graphical interface so that a graphical user interface is displayable on a screen.

This makes it possible to use one's own graphical user interface (GUI). Someone who's supposed to provide the functionality to the end user therefore does not need to have any knowledge about the particular database models or the database meta-description layers. It is also not necessary to have any knowledge about object-oriented programming since only services are called to which specific parameters are assigned or accessed. A GUI, that is adapted in terms of look and feel and of specific requirements for terminals or for specific companies, can thus be provided independently of the platform.

In an embodiment, the previously described computer system has a terminal, which has a screen, wherein the screen displays the graphical user interface.

The present computer system in particular includes several computers and/or terminals in a network.

The present invention is described in more detail based on an embodiment.

A first database 121 for student management at a university has a first table 123, in which the student name, the student number, the field of study and the student matriculation status etc., of various students are stored line-by-line in columns X1, X2, X3, . . . .

The first database 121 additionally comprises a second table 125, in which course catalogue information is stored. The course number, the lecture room, the subject of the lecture, the building in which the lecture will take place and the like are stored in the individual columns Y1, Y2, Y3, . . . . The individual lectures are listed in the lines.

A second database 131, which is a personnel database, comprises a first table 133. The first table 131 lists the status, such as professor or docent, and name, address, subject, salary and the like.

The first database 121 runs on a first virtual server and the second database 131 runs on a second virtual server. Together, they form the database system 120. Alternately, the first database runs on a first server and the second database 131 runs on a second locally distant server. The servers are connected via a network for exchanging data.

The meta-description layer 110 with the meta-description 111 is assigned to the database system 120. The meta-description 111 was created by means of the programming environment 113. The meta-description 111 specifies that a first table 123 with student information and a second table 125 with the relevant course information are stored in the first database 121.

The meta-description 111 thus knows the database as well as the individual table names. The meta-description 111 also stores the columns, titles and corresponding data type such as, for example, integer or string. A specific database field, which results from the precise specification of the line and column, can also be overwritten or read by way of a reference 115. The same applies to the reference 117, which can read, write or store a specific database field of the course table 125.

The meta-description 111 also comprises meta-information regarding the first table 133 of the second database 131 (personnel database). Here too, the individual columns, titles and data types of the individual database fields are accessible by means of reference 119.

The object-oriented communication layer 101 was created by means of the programming environment 113. In doing so, a connection of the individual object-oriented calls and commands was adapted to the corresponding functions and calls of the meta-description 111 so that a coupling 103 between the object-oriented communication layer 101 and the meta-description is provided.

The object-oriented calls and commands are provided by way of the access interface 105 of the service layer 141.

The service layer 141 can in particular comprise three different layers, such as, for example, an integration layer, a business process layer, and a service providing layer, so that the object-oriented commands and calls of the object-oriented communication layer 101 or correspondingly of the access interface 105 are processed so that corresponding services are provided to a display layer 151, so that so-called graphic user interfaces (GUI) are passed on to, e.g., a laptop 161 with a corresponding keyboard 163 and screen 165 by means of a connection 167.

For example, an end user uses a GUI previously set up for him on a laptop by way of keyboard entries. In the present case, a new student must be input into the database. Data about the student is managed by choosing a corresponding input field on the screen 165 by means of the keyboard 163.

This data is passed on through the display layer 151 to the service layer 141 by calling a service. The service layer 141 transforms the transferred information so that the corresponding object-oriented commands and calls are transmitted to the object-oriented communication layer 101 by means of the access interface 105.

In the present case, the service layer 141 and the display layer 151 are a part of the laptop.

These layers can alternatively already be installed on the server side.

The object-oriented calls are transformed in the object-oriented communication layer 101 in accordance with the programming and the coupling 103 so that the meta-description 111 and the corresponding programming result in storage of a new student and corresponding information in the table 123.

To this end, a new line is created in the table 123, into which the individual data items are inserted. The meta-description 111 specifies that a student number was automatically generated. This student number is checked and, if required, transmitted in the database via the reference 115 and the meta-description 111 and a query by way of the object-oriented communication layer 101 and the access interface 105 to the service layer 141, which in turn transmits it to the display layer 151, and is displayed via the connection 167 on the screen 165 of the laptop.

The present invention is not limited to embodiments described herein; reference should be had to the appended claims.

### LIST OF REFERENCE NUMBERS

101 Object-oriented communication layer
105 Access interface
110 Meta-description layer
111 Meta-description
113 Programming environment
115 Reference to table 1 (123) of database 1(121)
117 Reference to table 2 (125) of database 1 (121)
119 Reference to table 1 (123) of database 2 (131)
121 Database system
121 Relational database 1
123 Table 1 of the relational database 1 (121)
125 Table 2 of the relational database 1 (121)
131 Relational database 2
133 Table 1 of the relational database 2(131)
141 Service layer
151 Display layer
161 Laptop
163 Keyboard
165 Screen
167 Connection

What is claimed is:

1. An intermediate layer for abstracting a database meta-description layer with a coupling unit and an access interface configured to be object-oriented,
wherein,
a connection with the database meta-description layer is implementable by the coupling unit,
the database meta-description layer is configured to refer to,
at least one of a first database field and other database fields of at least one of a first database and other databases via a meta-description of the at least one of a first database and other databases,
via at least one of a first reference and other references,
so that the at least one of a first database and other databases are at least one of accessible and manipulable, and
the access interface comprises an object-oriented configuration so that the at least one of a first database and other databases is/are at least one of accessible and manipulable via object-oriented calls of the access interface by using at least one of the meta-description, the first reference, and the other references.

2. The intermediate layer as recited in claim 1, wherein the access interface is configured to be object-oriented so as to provide at least one of a class, an object, a method, a function and an attribute so that a specific database query or a specific database manipulation is implementable.

3. A database meta-description layer for describing and communicating with a database or with several databases, the database meta-description layer comprising an intermediate layer for abstracting a database meta-description layer with a coupling unit and an access interface configured to be object-oriented,
wherein,
a connection with the database meta-description layer is implementable by the coupling unit,
the database meta-description layer is configured to refer to,
at least one of a first database field and other database fields of at least one of a first database and other databases via a meta-description of the at least one of a first database and other databases,
via at least one of a first reference and other references,
so that the at least one of a first database and other databases are at least one of accessible and manipulable, and
the access interface comprises an object-oriented configuration so that the at least one of a first database and other databases is/are at least one of accessible and manipulable via object-oriented calls of the access interface by using at least one of the meta-description, the first reference, and the other references.

4. The database meta-description layer as recited in claim 3, further comprising a programming configured to implement a manipulation of a content of the at least one of a first database and other databases, the programming being written by a programming environment so that the meta-description and a reference of the at least one of a first database and the other databases are adapted.

5. The database meta-description layer as recited in claim 4, wherein a functionality of the intermediate layer is created by the programming environment.

6. A database to which the database meta-description layer as recited in claim 3 is attributed so that the database is at least one of accessible and manipulable by the access interface.

7. A database system comprising at least one of a first database and other databases to which exactly one database meta-description layer as recited in claim 3 is attributed so that the at least one of a first database and other databases are at least one of accessible and manipulable via the access interface.

8. The database system as recited in claim 7, wherein at least two databases of the at least one of a first database and other databases have a different data model.

9. A computer or a computer system comprising at least one of:
a database to which the database meta-description layer as recited in claim 3 is attributed so that the database is at least one of accessible and manipulable by the access interface, and
a database system comprising at least one of a first database and other databases to which exactly one database meta-description layer as recited in claim 3 is attributed so that the at least one of a first database and other databases are at least one of accessible and manipulable via the access interface.

10. The computer or the computer system as recited in claim 9, further comprising:
a screen configured to display a graphic user interface;
a display layer;
a graphic interface; and
a service layer configured to access the access interface, the service layer comprising services which are attributable to at least one of the display layer and the graphic interface so that the graphic user interface is displayable on the screen.

11. The computer system as recited in claim 10, further comprising a terminal comprising the screen, wherein the screen is configured to display the graphic user interface.
